(19) United States
(12) Patent Application Publication
(10) Pub. No.: US 2005/0267915 A1
(43) Pub. Date: Dec. 1, 2005

(54) Method and apparatus for recognizing specific type of information files

(75) Inventors: Wang Zhulong, Beijing (CN); Yu Hao, Beijing (CN); Fumihito Nishino, Kanagawa (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/135,658

(22) Filed: May 24, 2005

(30) Foreign Application Priority Data
May 24, 2004 (CN) 2004-100383575

(51) Int. Cl. G06F 17/30

(52) U.S. Cl. 707/200

(57) ABSTRACT

The present invention provides a file recognition apparatus and method for recognizing specific information type with respect to a web page file group collected from the Internet or stored in other storage apparatus. The file recognition apparatus of the invention comprises: a file grouping section for classifying, from a predetermined viewpoint, the file group to be recognized by file type; a file type recognition section for recognizing the type of the files according to characteristics specific to the specific information type; and a file-type-recognition correction section for correcting the recognition result of each file in consideration of the recognition precision of all files in the group. The apparatus and method of the invention can recognize various types of information, and can obtain satisfying reorganization precision.

### TECHNICAL FIELD

The present invention relates to a method and apparatus for recognizing specific type of information files.

### BACKGROUND ART

The information is usually stored and archived in the form of files. Similarly, the information broadly spreading on Internet is also distributed and transmitted in the form of Web files. With the fast development of the Internet, the amount of Web file information is increasingly growing up and accounts for a substantial proportion, thus making more significant the importance of the information processing techniques on Internet such as classification and retrieval of Web files. Also with the fast development of networks, the subscribers' demands for online information are getting diverse. Generally, the searching method based on string matching could well satisfy the subscribers' requirements for searching refined information. However, classification or recognition of some file groups characterized by information types is not so satisfying.

Today, with the high speed development of networks, information carried by Web pages is getting highly integrated and the content thereof is getting more and more complicated and diverse. Many information contents such as hyper link and hyper media information have become indispensable parts of the Web pages. It increased the amount of transmittable information and improved the user interfaces to a certain extent, on the other hand, it renders the structures of Web pages complicated, brings about various topics in the Web information and adds noise to the main information contents. Heretofore, many researchers engaging in Web information processing proposed various Web information-blocking method in an attempt to accurately understand and extract main information, such as:

Ziv Bar-Yossef and Sridhar Rajagopalan 2002. Template Detection via Data Mining and its Applications. In Proceedings of the WWW2002, May 7-11, 2002, Honolulu, Hi., USA.

Shian-Hua Lin, Jan-Ming Ho 2002. Discovering Informative Content Blocks from Web Documents. SIGKDD '02, Jul. 23-26, 2002, Edmonton, Alberta, Canada.

As is well known, in the Web information, the information carried on Web is organized and expressed by HTML description language, and the Web information is interpreted and displayed to the end users with Web browsers. Seemingly, this kind of information flow is a linear text information flow, but actually, the Web information flow has certain organization structures. The composition structure analysis of Web file, which is also a key technique of Web page information processing, shall be conducted prior to processing of Web information. In the Web pages, the page contents are organized with HTML description language, and the information structure thereof can be mapped to a DOM (Document Object Model) tree with HTML Tag and Web text information as its nodes. The existing browsers display Web pages by parsing DOM tree structure of Web pages. Text information in Web pages is organized with information to be conveyed with Tags defined in HTML. Structure trees of Web information can be processed by parsing the functional attributes of the tags. (Ziv Bar-Yossef 2002) proposed a relatively simple heuristic page blocking method that partitions Web pages based on semantic consistency of information by using DOM tree and different attributes of HTML Tags, so as to separate different information topics. (Shian-Hua Lin 2002) proposed a method for detecting and partitioning information blocks of Web pages by utilizing HTML Tags such as <Table>. It can be seen that both methods partition Web pages by using different attributes of HTML Tags in order to extract desired information contents of the users.

### SUMMARY OF THE INVENTION

In order to address the above-mentioned problem in classifying and recognizing file group characterized by information type, the present invention provides a method and apparatus for recognizing specific type of information files, which can conduct a file type-based recognition on Web pages collected from Internet or file groups stored in related storage apparatus. Based on the fact that files of the same type have attributes specific thereto that can be effectively utilized in file type recognition, the invention groups the input files, which achieves an effect of pre-classification of file samples, and contributes to the improvement of recognition precision. In an aspect of the invention, there is provided a file recognition apparatus, which comprises: a file grouping section for classifying the files to be recognized by types in the viewpoints such as URL and author names, and grouping the files based on their attributes, so that the subsequent recognition modules can conduct recognition based on the file attributes of each groups, the file grouping section also serves an effect of pre-classification of the samples, and improves the ultimate recognition precision of the system; a file type recognition section for extracting main information blocks of a file based on inherent DOM structure of the Web page and attributes of HTML Tags, and determining the information type, such as lyric, log and BBS, of the file, the file type recognition section recognizes file types based on characteristics specific to the above-mentioned specific information, such as key words, punctuation marks, document structure and repetition of contents; and a file-type-recognition correction section for correcting, in consideration of recognition precision of whole files in conjunction with recognition results of each individual files, all file recognition results of the group, with special attention paid to the overall recognition accuracy of all files in the group, so as to improve the overall recognition precision of all files.

Preferably, in the file recognition apparatus of the invention, the file type recognition section comprises a main-information-block extraction unit for extracting main information block from files and removing noise components that have no significance to the file.

Preferably, in the file recognition apparatus of the invention, the file-type-recognition correction section summarizes the recognition result of each file in current file subgroup, calculates a ratio of number of files recognized as positive example to the number of files in current subgroup by taking the current file subgroup as an unit, and determining the current file subgroup by comparing the ratio to a predetermined threshold value.

In another aspect of the invention, there is provided a file recognition method for recognizing a specific information type with respect to a file group collected from the Internet or stored in other storage apparatus, the method comprising steps of: classifying the files to be recognized by file types from a predetermined viewpoint; recognizing the types of the files based on characteristics specific to the specific information type; and correcting the recognition result of each file in consideration of the recognition precision of all files in the group.

Preferably, in the file recognition method of the invention, the step of recognizing further comprises a step of removing noise components that have no significance to the file, and extracting only the main part.

Preferably, in the file recognition method of the invention, the step of correcting summarizes the recognition result of each file in current file subgroup, calculates a ratio of number of files recognized as positive example to the number of files in current subgroup by taking the current file subgroup as an unit, and determine the current file subgroup by comparing the ratio to a predetermined threshold value.

### DESCRIPTION OF THE DRAWINGS

FIG. 1 shows the structure of the file recognition apparatus of the invention;

FIG. 2 shows the structure of file type recognition section;

FIG. 3 shows the structure of the template-information-for-subgroup extraction unit in the file type recognition section;

FIG. 4 shows the page parsing process in the template-information-for-subgroup extraction unit of the file type recognition section;

FIG. 5 shows an example of DOM tree of Web page file;

FIG. 6 shows a flow chart of the process of the template-information-for-subgroup extraction unit;

FIG. 7 shows the structure of the main-information-block extraction unit in the file type recognition section;

FIG. 8 shows a flow chart of the process of the main-information-block-of-file-in-subgroup extraction unit;

FIG. 9 shows the structure of the main-information-block-of-file recognition unit in the file type recognition section.

### DESCRIPTION OF THE EMBODIMENTS

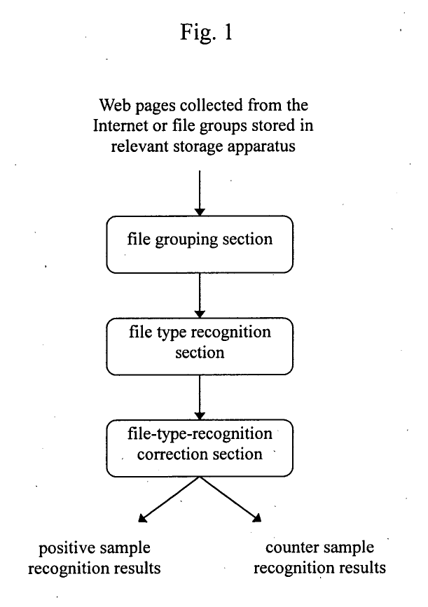

An embodiment of the apparatus for recognizing specific type of information files of the invention and the reorganization method used therein will be described with reference to the drawings, with the reorganization of lyric pages as an example. FIG. 1 shows the schematic structure of the file recognition apparatus of this invention. The file recognition apparatus of this invention has an input and an output, and consists mainly of three sections: (1) file grouping section; (2) file type recognition section; and (3) file-type-recognition correction section. Detailed description will be as follows. The input of the file recognition apparatus of the invention are Web pages collected from the Internet or other file groups stored in related storage apparatus. The output are two classified file sets processed by this recognition apparatus, i.e., positive example recognition result set and counter example recognition result set. The positive sample recognition results are specific information type recognized by this system, for example, lyric pages in this embodiment. The counter sample recognition results are those recognized by this system as not the specific information type, for example, files that are recognized as non-lyric pages in this embodiment.

(1) File Grouping Section

First of all, this file grouping section conducts a file type classification on the input file groups, which are Web pages collected from the Internet or file groups stored in other storage apparatus, based on various viewpoints such as URL and author names.

In most of the conventional systems, all files to be recognized are equal to the recognition system, and the system recognizes and determines each individual file with the same method and resources. This is basically reasonable in the viewpoint of system modeling and is fair to each files to be recognized. However, there are certain associations among files in practical applications, and such associations exhibit in form of specific file attributes, while the conventional systems failed to make use of this characteristic. The file grouping section of this invention is just based on this consideration, and classifies files in different viewpoints such as URLs and author names and takes respective classes as input of the system. Thus the individual files can be associated and the system can conduct recognition based on common attributes of each group.

From the viewpoint of the system overall recognition function, the file grouping section bring to an effect of pre-classification of the input samples, which contributes to the improvement of the ultimate overall recognition precision of the system.

(2) File Type Recognition Section

In the file type recognition section, the structure information of the DOM trees and the attributes of HTML Tags are fully exploited to extract main information blocks from complicated Web pages. In this case, the invention adopts a method for extracting main information block from Web page based on web page template information, in order to remove the interference of noise components to reorganization of the web main information and therefore to improve the reorganization precision of the system.

The file type recognition section extracts main information block of the file based on inherent DOM structure of the Web pages and attributes of HTML Tags, and determines the specific information type (lyric information) of the file based on the main information contents. Then it uses characteristics specific to lyric information which is a type of specific type information, such as key words, punctuation marks, document structure and repetition of contents, to recognizing file type.

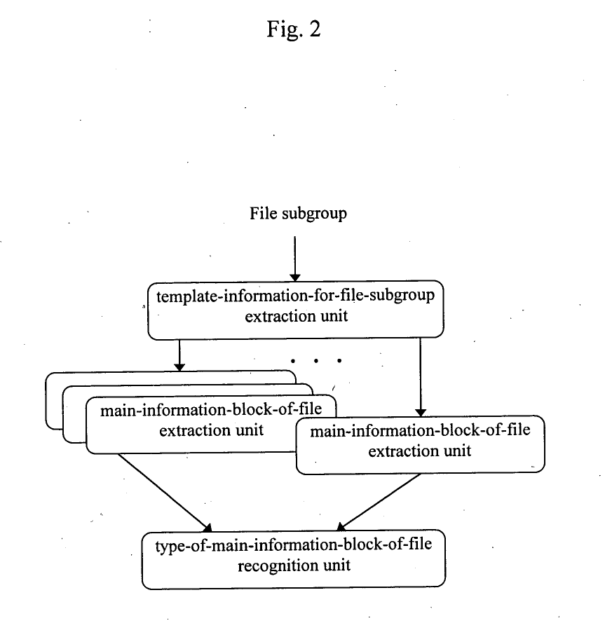

FIG. 2 illustrates the implementation of the file type recognition section. The input of the file type recognition section are file subgroups as grouped by the file grouping section based on various viewpoints such as URL. Specifically, the file type recognition section comprises: a template-information-for-file-subgroup extraction unit, a main-information-block-of-file extraction unit and a type-of-main-information-block-of-file recognition unit. The function of the template-information-for-file-subgroup extraction unit is to extract template information of Web pages by analyzing their HTML structure documents with template training set for the file subgroups. The main function of the main-information-block-of-file extraction unit is to extract main information from each file in the file subgroup with the file subgroup template information extracted by the template-information-for-file-subgroup extraction unit. The main-information-block-of-file extraction unit can eliminate most of noise information from the Web pages, and therefore guarantee the subsequent file type recognition. Meanwhile, in implementing the main-information-block-of-file extraction unit, multi-thread technology can be applied to realize concurrent process and therefore to improve processing speed of the system. The function of type-of-main-information-block-of-file recognition unit is to recognize file types based on characteristics specific to lyric Web pages which is of a specific information type, such as key words, punctuation marks, document structure and repetition of contents. The input of the type-of-main-information-block-of-file recognition unit are the main information contents as extracted from each files.

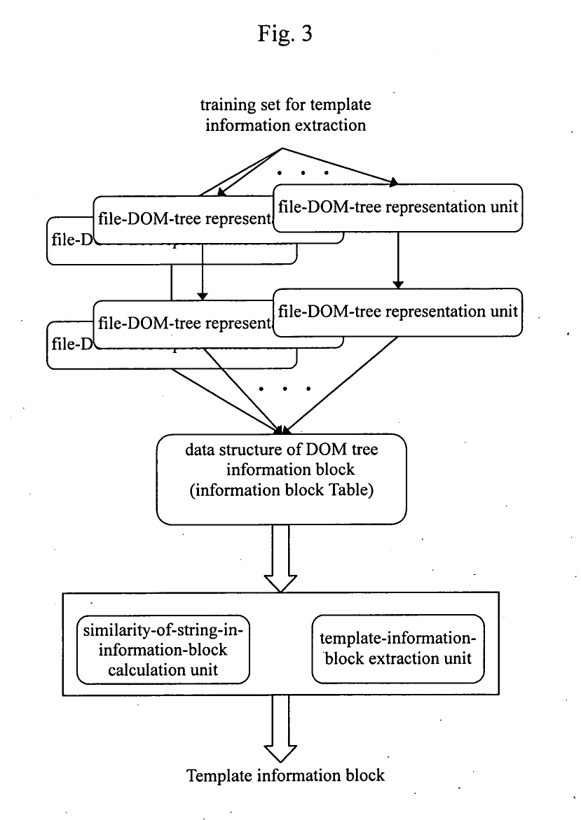

FIG. 3 shows the internal function implementation of the template-information-for-file-subgroup extraction unit. The input are template information extraction training set in the file subgroup as classified by the file grouping section. This section mainly realizes the template information extraction of file subgroup, its main components include a file-DOM-tree representation unit, an information-blocks-of-leaf-node-in-DOM-tree merging unit, a data-structure-of-information-block-of-DOM-tree (information block Table) representation unit, a similarity-of-string-in-information-block calculation unit, and a template-information-block extraction unit.

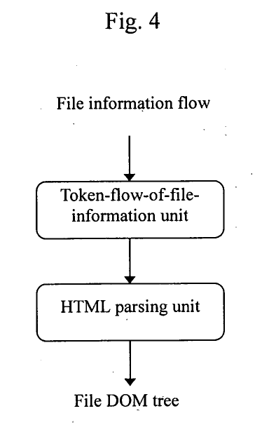

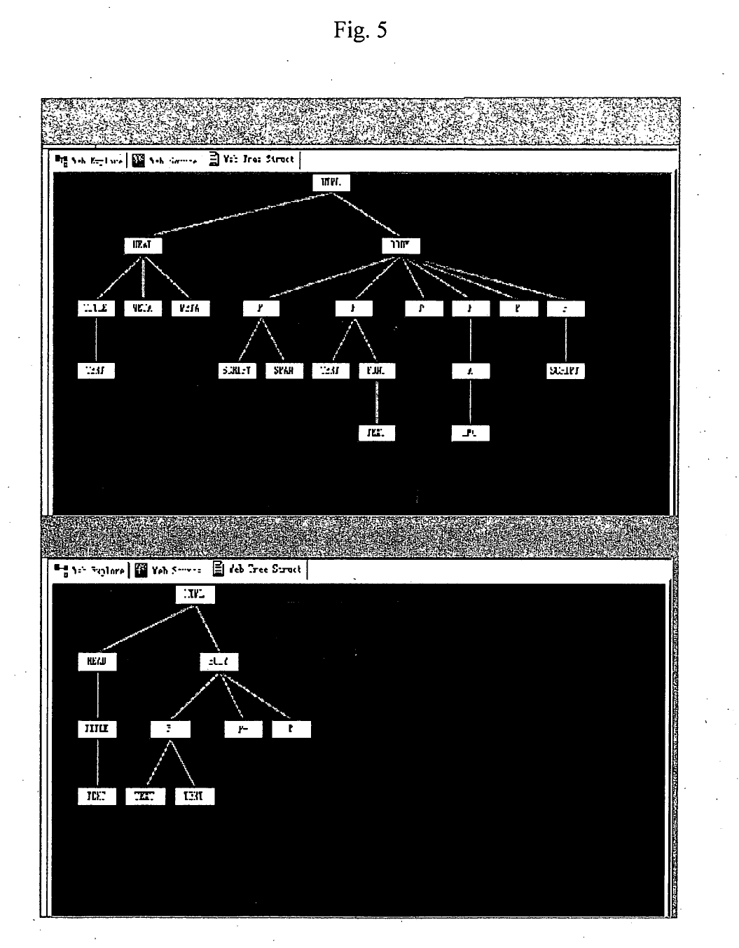

1. As a key technology in Web page information processing, the file-DOM-tree representation unit realizes the mapping of linear flow of a Web page source code to DOM tree structure of the Web file, and underlies the subsequent file structure analysis. As is known, Web pages, in which the information contents to be conveyed are formatted with HTML description language, consists of HTML Tag information, notes information and main information to be conveyed. The notes information is of no help to the structure analysis, while the Tag information contains abundant structure information. In the DOM tree, information to be conveyed by Web pages usually exists in the form of leaves with the node attribute thereof being text attribute. FIG. 4 illustrates the parsing process for a Web page. The file flow flows into the Token-flow-of-file-information unit and is classified into the above-mentioned three information types based on their attributes, each type of which is called a Token flow. Such a Web page is regarded as consisting of a series of Token flows. These Token information flows will flow into the HTML Parsing section which Parses the Token information flows based on the attributes of each Tags, in accordance with the HTML version standard issued by W3C, and obtains a DOM tree corresponding to this Web page. FIG. 5 shows an example of DOM tree for a Web page, in which the TEXT nodes stand for main information text nodes to be conveyed by the Web page, other nodes stand for HTML Tag marks, and line segments stand for the parent-child relationship between two nodes.

2. The information-blocks-of-leaf-node-in-DOM-tree merging unit realizes delimitation and positioning between different information blocks in a Web page. The HTML source files of Web page files are displayed to users after being interpreted by a browser. From the viewpoint of display effect, the organization of information has certain structure and different text information aggregate to a certain extent in different locations in the Web page, i.e., exist in form of information blocks. There are also certain associations among corresponding nodes on DOM tree of the Web page. This merging unit realizes the merging of information blocks as follows.

In order to find out relationship between information blocks with HTML DOM tree, the DOM tree need to be processed first to eliminate irrelevant information nodes such as script nodes, and to mark out significant nodes. The following is the merging method for information blocks:

(a) Defining Relevant Symbols Used in the Algorithm
N denotes a node in the DOM tree;
DN denotes that the current node is not a text information node but exists as a leaf node in the DOM tree;
LN denotes that the current node is a leaf node in the DOM tree and meanwhile a text node

(b) Traversing the Entire DOM Tree for the Web Page with a Depth-First Postorder and checking each node in the following way:

Step 1:
(i) If the current node N is not a leaf node of the DOM tree, do nothing and check the next node;
(ii) If the current node is a LN node of the DOM tree, cancel this node and check the next node;

All the DN nodes will be canceled up to now.

Step 2:
(i) If the current node N is a leaf node of the DOM tree, do nothing and check the next node;
(ii) If the parent node of the current node N has only one child node and the current node N has only one leaf node, then:
1) Cancel the current node N;
2) Let the child node of the current node N be a child node of the current node's parent node, and place it sequentially behind other brother nodes;
3) Go on traversing other nodes of the entire tree;

A relatively compact Web Page DOM tree can be obtained after canceling unreasonable nodes in the tree. Now, if we cascade contents of all leaf nodes of different child tree, we can find that each string stands for an information string, i.e., the Web Page information block.

3. The data-structure-of-information-block-of-DOM-tree representation unit converts the Web page information as node-merged into a data structure of web page information blocks. After being processed by the information-blocks-of-leaf-node-in-DOM-tree merging unit, the Web page information is divided into different information blocks. For the purpose of the subsequent extraction of template information block, the processed DOM tree information contents are copied to the data structure of the DOM tree information blocks. This data structure is a chain table structure in which each node stores one information block content of the Web page. The data-structure-of-information-block-of-DOM-tree representation unit copies all leaf nodes of corresponding information block child tree in the processed DOM tree sequentially to the nodes of chain table, in an order of from left to right.

4. The similarity-of-string-in-information-block calculation unit calculates the similarity between two strings. The similarity between strings is defined as the similarity degree of the two strings as calculated. A double type variable lying within the range of [0,1] is used to denote the similarity, 0 for no similarity and 1 for identical strings. In this calculation unit, similarity calculation is accomplished by calculating edit-distance of two strings. Three edit operations for characters: insertion, canceling and swapping, are defined, and operation function costs of these three operations are set to 1. Then dynamic programming method will be applied to calculate their similarity.

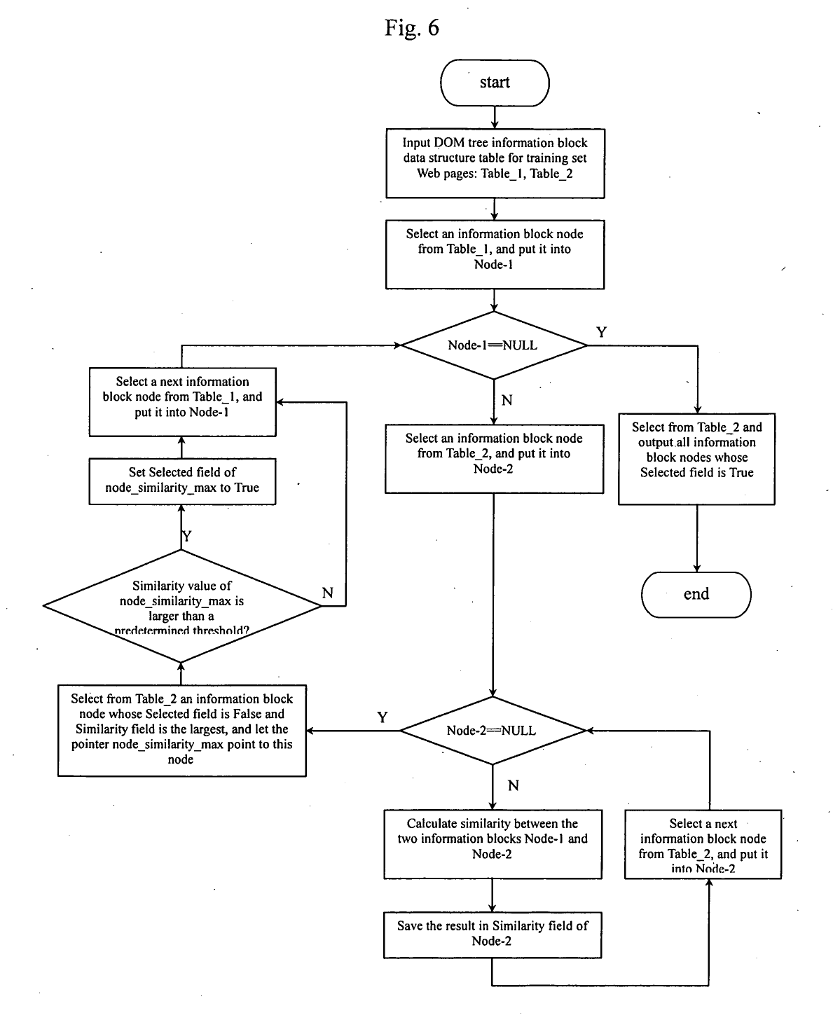

5. The template-information-block extraction unit extracts template information for Web page training set (two representative Web pages). After processing of the above-mentioned units, data structure of DOM tree information block corresponding to the training set Web pages (such as the two input chain tables Table_1 and Table_2 shown in FIG. 6) can be obtained. Detailed algorithm is shown in FIG. 6. After processing of this algorithm, Web page template information for the current file grouping section will be obtained.

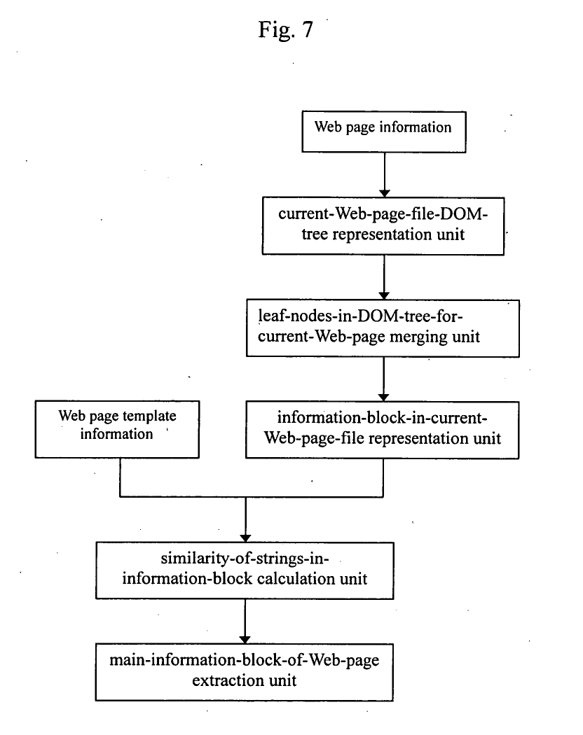

FIG. 7 illustrates the internal function realization of the main-information-block-of-file extraction unit. The input is template information extracted from the file subgroup and Web page information currently to be recognized. This unit mainly realizes the main information extraction from the current Web page, and comprises a current-Web-page-file-DOM-tree representation unit, a leaf-nodes-in-DOM-tree-for-current-Web-page merging unit, an information-block-in-current-Web-page-file representation unit, an similarity-of-strings-in-information-block calculation unit, and a main-information-block-of-Web-page extraction unit.

1. The specific algorithm for the current-Web-page-file-DOM-tree representation unit is the same as that for the file-DOM-tree representation unit of the template-information-for-file-subgroup extraction unit.

2. The specific algorithm for the leaf-nodes-in-DOM-tree-for-current-Web-page merging unit is the same as that for the Information-blocks-of-leaf-node-in-DOM-tree merging unit of the template-information-for-file-subgroup extraction unit.

3. The specific algorithm for the information-block-in-current-Web-page-file representation unit is the same as that for the Data-structure-of-information-block-of-DOM-tree representation unit of the template-information-for-file-subgroup extraction unit.

4. The specific algorithm for the similarity-of-string-in-information-block calculation unit is the same as that for the information block strings similarity calculation unit of the template-information-for-file-subgroup extraction unit.

5. The main-information-block-of-Web-page extraction unit extracts the main information block from the Web page information.

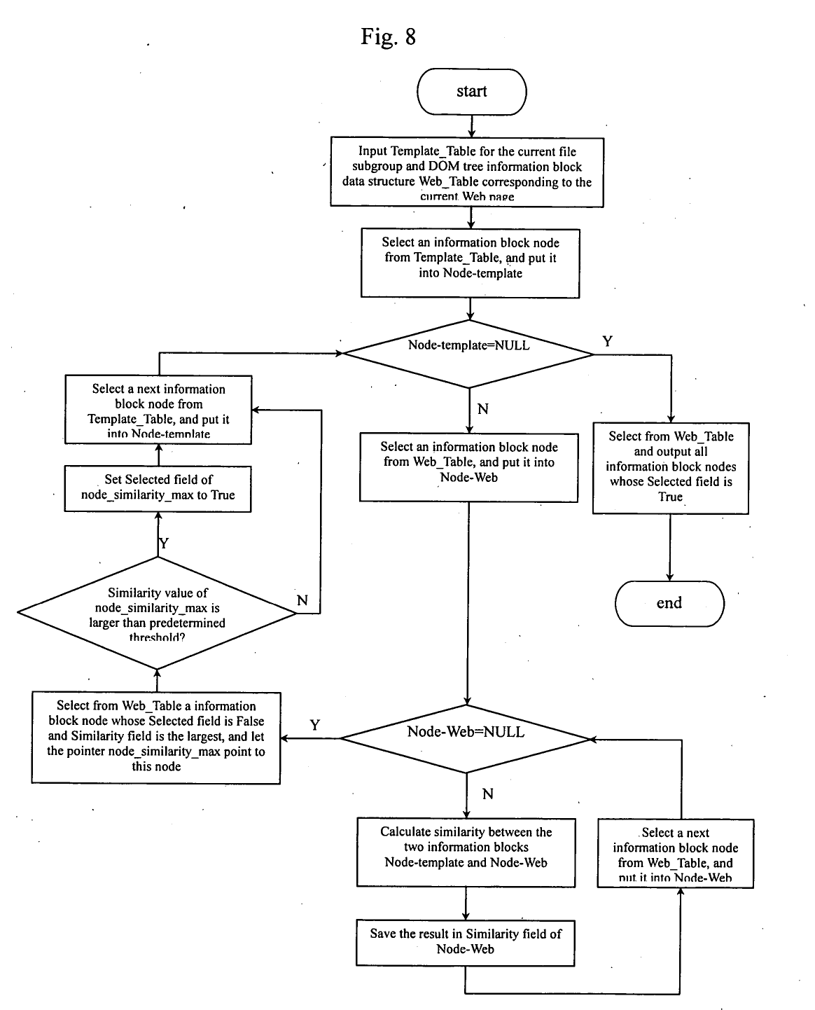

After processing of the above-mentioned units, data structure of information block of DOM tree corresponding to the current Web page (such as the input chain table Web_Table shown in FIG. 8) will be obtained and template information of current file subgroup (such as the input chain table Template_Table shown in FIG. 8) will be applied. The specific algorithm is shown in FIG. 8. Main information block of the current Web page file can be obtained after the processing of this algorithm.

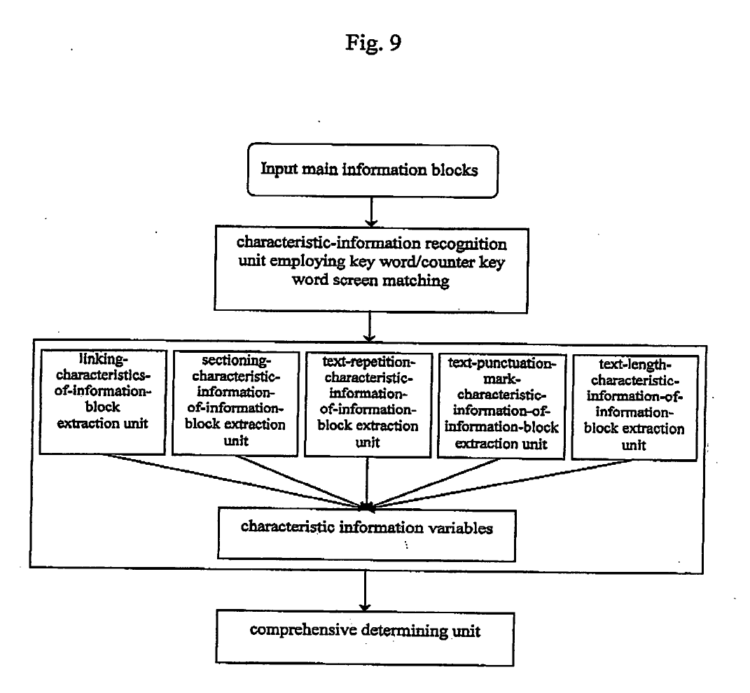

FIG. 9 shows the internal function implementation of the main-information-block-of-file recognition unit. The input is the main information block of the Web page. This unit is mainly for recognizing the main information block of the Web pages with various methods, and comprises a characteristic-information recognition unit employing key word/counter key word screen matching, an linking-characteristics-of-information-block extraction unit, an sectioning-characteristic-information-of-information-block extraction unit, an text-repetition-characteristic-information-of-information-block extraction unit, an text-punctuation-mark-characteristic-information-of-information-block extraction unit, an text-length-characteristic-information-of-information-block extraction unit and an comprehensive determining unit. The first 6 units extracts different characteristic information from the information block separately and save the extracted information in the characteristic information variables. Then the comprehensive determining unit makes a determination with respect to the information block based on these characteristic information variables and provides a final determination result for the Web page.

The characteristic-information recognition unit employing key word/counter key word screen matching searches and matches the main information block with key word characteristics and calculates the key work score of this Web page and saves it in the characteristic information variables. Three vectors, T_{c}, T_{f} and T_{w} are defined, where T_{c} is key word vector, T_{f} is appearance frequency vector of the key word in the current main information block and T_{w} is weight vector of the key word. After searching and matching each main information block, the current value of T_{f} can be obtained and the inner product T_{c}·T_{f}·T_{w}, i.e., the characteristic word score of the current Web page main information block, can be computed. The score is stored in the characteristic information variables for further determination.

The above key word searching and matching process uses the complete matching technology of string and therefore tends to ignore the error accumulation when the matched information isn't the “string sub-set” of non-key word information and the non-key word information expresses another semanteme. The “counter key word screen algorithm” is proposed to address this problem, i.e., matching with “key word matching algorithm” after pre-matching possible key word information of this kind.

Linking-characteristics-of-information-block extraction unit implements the summarizing analysis for chain table of main information block. In the linking-characteristics-of-information-block extraction unit, the length of the link text and the text length of current main information block are counted and the ratio of these two lengths is calculated. The result is saved in the characteristic variables for further determination.

The sectioning-characteristic-information-of-information-block extraction unit implements summarization of line segmentation information of the main information block. The number of sub-segment in each line is counted, the average number of line segment in the current main information block is obtained and saved in the characteristic variables for further determination. In this case, the line sub-segment is defined as the character segment in text information separated by one or more spaces.

The text-repetition-characteristic-information-of-information-block extraction unit implements the summarizing analysis of text repetition of the main information block. Firstly, it orders all lines in current main information block in unit of line according to text contents. Secondly, from the first line, it calculates similarity of each neighboring lines' text contents in turn and saves the calculation results in corresponding temporary variables. Finally, it counts the number of line information similarity that are bigger than a threshold and saves the information in characteristic variables for further determination.

The text-punctuation-mark-characteristic-information-of-information-block extraction unit implements the summarizing analysis of the punctuation mark characteristic information of main information block. It counts predetermined punctuation marks in the current main information block contents and saves the information in characteristic information variables for further determination.

The text-length-characteristic-information-of-information-block extraction unit implements the summarizing analysis of text length of main information block and saves the characteristic information in the characteristic information variables for further determination.

The comprehensive determining unit implements comprehensive determination of parameter values saved in characteristic information variables. This unit defines three parameters representing three performance levels for each characteristic information including key word, information block association, line segmentation of information block, text repetition of information block, text punctuation mark of information block and text length of information block, respectively, as shown in the following table:

| | | | Abbre- |
|---|---|---|---|
| No. | Variable definition | Value | viation |
| 1 | #define Web_KEYWORD_HG | (1 << 0) | KEY_H |
| 2 | #define Web_KEYWORD_GEN | (1 << 1) | KEY_G |
| 3 | #define Web_KEYWORD_LW | (1 << 2) | KEY_L |
| 4 | #define | (1 << 3) | HTML_H |
| | Web_HTMASSOCIATION_HG | | |
| 5 | #define | (1 << 4) | HTML_G |
| | Web_HTMASSOCIATION_GEN | | |
| 6 | #define | (1 << 5) | HTML_L |
| | Web_HTMASSOCIATION_LW | | |
| 7 | #define | (1 << 6) | LINE_H |
| | Web_LINESEGEMENTNUM_HG | | |
| 8 | #define | (1 << 7) | LINE_G |
| | Web_LINESEGEMENTNUM_GEN | | |
| 9 | #define | (1 << 8) | LINE_L |
| | Web_LINESEGEMENTNUM_LW | | |
| 10 | #define Web_SIMILARITY_HG | (1 << 9) | SIM_H |
| 11 | #define Web_SIMILARITY_GEN | (1 << 10) | SIM_G |
| 12 | #define Web_SIMILARITY_LW | (1 << 11) | SIM_L |
| 13 | #define Web_PUNCTUATION_HG | (1 << 12) | PUN_H |
| 14 | #define Web_PUNCTUATION_GEN | (1 << 13) | PUN_G |
| 15 | #define Web_PUNCTUATION_LW | (1 << 14) | PUN_L |
| 16 | #define Web_TOTALLEN_HG | (1 << 15) | TOTA_H |
| 17 | #define Web_TOTALLEN_GEN | (1 << 16) | TOTA_G |
| 18 | #define Web_TOTALLEN_LW | (1 << 17) | TOTA_L |

The values can be selected based on predetermined threshold values, and the type of main information blocks can be determined with a heuristic rule. In this embodiment, the following heuristic rule are adopted:

| No. | Rule |
|---|---|
| RULE1 | KEY_H |
| RULE2 | LINE_H \| SIM_H \| HTML_L \| TOT_G \| KEY_G |
| RULE3 | LINE_G \| PUN_L \| SIM_H \| HTML_L \| TOT_G \| |
| | KEY_G |
| RULE4 | LINE_G \| PUN_L \| SIM_H \| HTML_L \| TOT_G \| |
| | KEY_G |
| RULE5 | LINE_H \| PUN_L \| HTML_L \| TOT_G \| KEY_G |
| RULE6 | LINE_H \| PUN_H \| SIM_H \| TOT_G \| HTML_L \| |
| | KEY_L |
| RULE7 | LINE_H \| PUN_H \| SIM_H \| TOT_G \| HTML_L \| |
| | KEY_L |
| RULE8 | LINE_H \| PUN_G \| SIM_H \| TOT_G \| HTML_L \| |
| | KEY_L |
| RULE9 | LINE_H \| PUN_G \| SIM_H \| TOT_G \| HTML_L \| |
| | KEY_L |
| RULE10 | LINE_H \| PUN_L \| SIM_H \| TOT_G \| HTML_L \| |
| | KEY_L |
| RULE11 | LINE_H \| PUN_L \| SIM_H \| TOT_G \| HTML_L \| |
| | KEY_L |
| RULE12 | LINE_H \| PUN_L \| SIM_G \| TOT_G \| HTML_L \| |
| | KEY_L |
| RULE13 | LINE_H \| PUN_L \| SIM_L \| TOT_G \| HTML_L \| |
| | KEY_L |

All files with the characteristic information variable determined based on the current information block matching the above-mentioned rules are determined as positive example recognition results, otherwise as negative example recognition results.

(3) File-Type-Recognition Correction Unit

The file-type-recognition correction section corrects all reorganization results in the current group in consideration of the overall recognition results of files in the same group and in conjunction with recognition results of each individual files, with special attention paid to the overall recognition accuracy of all files in the group. Specifically, the file-type-recognition correction section summarizes recognition results for each file in current file subgroup, takes the current file subgroup as an unit and calculates the “correct recognition rate” of this subgroup, i.e., the ratio of number of files recognized as positive example to the number of files in current subgroup, and makes a determination with respect to the current file subgroup based on a predetermined threshold value.

An embodiment of the reorganization apparatus and method according to the invention has been described by taking the reorganization of lyric web pages as an example. However, the invention is not limited to the reorganization of lyric web pages, and instead can be applied to all kind of information files. In addition, details as described above are merely illustrative and for providing a better understanding of the invention. Various modifications and variations can be made to the reorganization apparatus and method according to the invention within the scope as defined in the claims.

1. A file recognition apparatus for recognizing specific information type with respect to a web page file group collected from the Internet or stored in other storage apparatus, the file recognition apparatus comprising:
a file grouping section for classifying, from a predetermined viewpoint, the file group to be recognized by file type;
a file type recognition section for recognizing the type of the files according to characteristics specific to the specific information type; and
a file type recognition correction section for correcting the recognition result of each file in consideration of the recognition precision of all files in the group.

2. The file recognition apparatus of claim 1, wherein the file type recognition section further comprises a main information block extraction section for removing noise components that have no significance to the file, and extracting only the main part.

3. The file recognition apparatus of claim 1, wherein the file type recognition correction section summarizes the recognition result of each file in current file subgroup, calculates a ratio of number of files recognized as positive example to the number of files in current subgroup by taking the current file subgroup as an unit, and makes a decision on the current file subgroup by comparing the ratio to a predetermined threshold value.

4. A file recognition method for recognizing specific information type with respect to a web page file group collected from the Internet or stored in other storage apparatus, the method comprising the steps of:
classifying, from a predetermined viewpoint, the file group to be recognized by file type;
recognizing the type of the files based on characteristics specific to the specific information type; and
correcting the recognition result of each file in consideration of the recognition precision of all files in the group.

5. The file recognition method of claim 4, wherein the step of recognizing further comprises a step of removing noise components that have no significance to the file, and extracting only the main part.

6. The file recognition method of claim 1, wherein the step of correcting summarizes the recognition result of each file in current file subgroup, calculates a ratio of number of files recognized as positive example to the number of files in current subgroup by taking the current file subgroup as a whole, and makes a decision on the current file subgroup by comparing the ratio to a predetermined threshold value.
